(19) United States
(12) Patent Application Publication
(10) Pub. No.: US 2006/0056936 A1
(43) Pub. Date: Mar. 16, 2006

(54) Fixing structure

(75) Inventors: Tsutomu Ishimaru, Sapporo-shi (JP); Michiaki Honma, Sapporo-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/211,628

(22) Filed: Aug. 26, 2005

(30) Foreign Application Priority Data
Aug. 26, 2004 (JP) P2004--246401

(51) Int. Cl. F16B 39/00

(52) U.S. Cl. 411/81

(57) ABSTRACT

A fixing structure includes a synthetic resin fixing part that is formed on a fixed member, a metallic collar adapted to be fixed in the portion to be fixed and having a bolt insertion hole and two engaging protrusions which are formed integrally with the fixing part so as to protrude into an interior of the bolt insertion hole. Then, when a bolt is inserted into the bolt insertion hole, the inserted bolt is then engaged with the engaging protrusions, whereby the fixed member is provisionally fixed to the bolt. In this state, a nut is fittingly screwed on a distal end portion of the bolt which protrudes from the bolt insertion hole.

### BACKGROUND OF THE INVENTION

1. Field of the Invention

The present invention relates to an improved fixing structure into which a bolt thread of a bolt is inserted.

2. Related Art

A wiring harness related synthetic resin fixed member such as a junction block, a relay block, a protector, a bracket and the like which are attached to a vehicle such as an automobile is fixed to a vehicle body with a bolt thread of a bolt. As shown in FIGS. 13 to 15, a portion 1 to be fixed to the vehicle has a synthetic resin attachment tab 2, which constitutes a fixing part, and a metallic collar 3. The attachment tab 2 is provided at a predetermined location of the fixed member, and the collar 3 is attached to the attachment tab 2. To be more specific, the collar 3 fits in a through hole 2a which is formed in the attachment tab 2 and is defined by a circular edge portion of the tab. The collar 3 is something like a hollow cylindrical member formed of a metal in order to satisfy a mechanical strength that is required when the collar 3 is fastened by a bolt thread and has a bolt insertion hole 3a that is defined by the circular edge portion and is formed to extend in an axial direction of the collar 3 and a flange portion 3b that is formed at one end portion of the collar 3. Then, the collar 3 is inserted into the through hole 2a of the attachment tab 2 from a small diameter side end portion 3c thereof and is fixed to the through hole 2a by forming crimp portions 3d by crimp machining the small diameter side end portion 3c. Note that in FIGS. 13 to 15, only the portion 1 to be fixed to the vehicle is shown which is formed on the fixed member. When assembling the fixed member, which is configured as has been described just above, to the vehicle, a bolt (not shown) that is planted on the vehicle body is inserted into the bolt insertion hole 3a of the collar 3, and a nut (not shown) is then fittingly screwed on the bolt.

Various directions are assumed as an attachment direction of the fixed member to the vehicle body; from above, from below, from left and from right. When the fixed member is fixed to a horizontal attachment surface while an attachment worker facing downwards, the fixed member is placed on the attachment surface while inserting a bolt thread such a bolt that is planted on the attachment surface into the bolt insertion hole 3a of the collar 3, and a nut is fittingly screwed on a distal end of the bolt thread that protrudes from the bolt insertion hole 3a, whereby the fixed member can easily be fixed to the horizontal attachment surface. However, in particular, when the fixed member is fixed to a horizontal attachment surface while the attachment worker facing upwards, that is, when the bolt insertion hole 3a of the collar 3 is fitted on a bolt that is planted on the attachment surface so as to suspend therefrom, the attachment worker needs to hold the fixed member with one of his or her hands in order to prevent the fall of the fixed member while preparing a fastening tool and a nut with the other hand. Due to this, since the fastening work has to done by the one hand, the work becomes difficult to be done and needs to take a long time. Thus, a plurality of pieces of work such as holding work and fastening work of the fixed member need to performed at the same time, and this constitutes one of causes of the reduction in working efficiency. On top of this, there is a possibility that irrespective of arrangement of the fixed member to a proper position, the fixed member falls from the bolt in the middle of preparing the nut and the fastening tool, and this leads to a possibility that the fixed member is disposed at a wrong position on the bolt during rearrangement of the fixed member so fallen and is then fastened by the nut at the wrong position.

### SUMMARY OF THE INVENTION

The invention was made in view of the situations described above, and an object thereof is to provide a fixing structure in which when a bolt thread of a bolt is inserted in a bolt insertion hole in a fixed member, the fixed member can be provisionally fixed to the bolt thread.

With a view to attaining the object, according to the invention, there is provided a fixing structure that is characterized as below.

(1) A fixing structure comprising:
a fixing part; and
a collar fixed in the fixing part and in which a bolt insertion hole is defined by an inner peripheral surface thereof;
wherein at least one engaging protrusion is protruded from the inner peripheral surface of the collar so as to be engageable with a bolt inserted in the bolt insertion hole such that the fixing part is provisionally fixed to the bolt.

Since the engaging protrusion protrudes into the bolt insertion hole of the collar so as to be engageable with the bolt thread that is inserted into the bolt insertion hole, the fixed member is provisionally fixed to the bolt thread. Consequently, since the fixed member falls from the bolt thread in no case even in case the hand of the attachment worker is removed from the fixed member after the bolt thread has been inserted in the bolt insertion hole, fastening work using both the hands is enabled, whereby efficient fastening work can be done. In addition, since the fixed member does not fall from the bolt thread, the erroneous assembly can be prevented.

(2) The collar may have a through hole which penetrates from an outer peripheral surface thereof into the bolt insertion hole, and the engaging protrusion may protrude from the inner peripheral surface to the bolt insertion hole through the through hole.

(3) The collar may be fixed in the fixing part by fitting the engaging protrusion to the through hole.

(4) The fixing part may be made of a synthetic resin and the collar may be made of a metal, and the engaging protrusion may be integrally formed with the fixing part.

If the engaging protrusion is integrally formed with the fixing part, the engaging protrusion can be prepared without increasing number of processes. In addition, the engaging projection can be provided with good accuracy and ease.

(5) The collar may be fixed in the fixing part by insert molding.

If the collar is insert molded in the fixing part of the fixed member such that the engaging protrusion protrudes into the bolt insertion hole through the through hole in the collar, the position and shape of the engaging protrusion can be prepared with good accuracy and ease.

(6) The collar may have a slit which penetrates from an outer peripheral surface thereof into the bolt insertion hole, and the engaging protrusion may protrude from the inner peripheral surface to the bolt insertion hole through the slit.

(7) The slit may extend from an axial end of the collar,
the fixing part may have a fitting hole that fits on the outer peripheral surface of the collar,
the engaging protrusion may be fitted in the slit so as to protrude in the bolt insertion hole when the collar is fitted in the fitting hole.

If the fixing part defines the fitting hole which fits on the outer peripheral surface of the collar, so that the engaging protrusion is fitted in the slit of the collar to thereby protrude into the bolt insertion hole when the collar is fitted in the fitting hole, the collar and the fixing part can be prepared as separate components, thereby making it possible to easily prepare a collar and a fixing part which are complex in shape.

(8) A flange portion may be formed in another axial end of the collar.

(9) A pair of the engaging protrusions may be formed so as to be opposite to each other on the inner peripheral surface.

(10) The collar may be substantially provided with a hollow cylindrical member formed of a metal.

(11) The bolt insertion hole may be defined in a flat circular shape in the collar, so that plural pairs of the engaging protrusions are formed on the inner peripheral surface of the collar.

As described above, when a bolt (or bolt thread) is inserted into the bolt insertion hole, the fixing part can be provisionally fixed to the bolt thread, whereby attachment work of the fixed member using both the hands of an attachment worker is enabled, and hence fastening work can be performed with good efficiency.

The invention has briefly been described. Furthermore, the details of the invention will further be clarified when a best mode for carrying out the invention, which will be described below, is read fully by reference to the accompanying drawings.

### BRIEF DESCRIPTION OF THE DRAWINGS

FIG. 1 is a perspective view of a fixing structure which is a first embodiment of the invention;

FIG. 2 is a cross-sectional view of the fixing structure taken along the line II-II in FIG. 1 as viewed in a direction indicated by arrows at ends of the line;

FIG. 3 is a perspective view of a collar in FIG. 1;

FIG. 4 is a perspective view of a fixing structure which is a second embodiment of the invention;

FIG. 5 is a cross-sectional view of the fixing structure taken along the line V-V in FIG. 4 as viewed in a direction indicated by arrows at ends of the line;

FIG. 6 is a perspective view of a collar in FIG. 4;

FIG. 7 is a perspective view of a fixing structure which is a third embodiment of the invention;

FIG. 8 is a cross-sectional view of the fixing structure taken along the line VIII-VIII in FIG. 7 as viewed in a direction indicated by arrows at ends of the line;

FIG. 9 is a perspective view of a collar in FIG. 7;

FIG. 10 is a perspective view of a fixing structure which is a fourth embodiment of the invention;

FIG. 11 is a cross-sectional view of the fixing structure taken along the line XI-XI in FIG. 10 as viewed in a direction indicated by arrows at ends of the line;

FIG. 12 is a perspective view of a collar in FIG. 10;

FIG. 13 is a perspective view of a conventional fixing structure;

FIG. 14 is a cross-sectional view of the fixing structure taken along the line XIV-XIV in FIG. 13 as viewed in a direction indicated by arrows at ends of the line; and

FIG. 15 is a perspective view of a collar in FIG. 13.

### DETAILED DESCRIPTION OF THE PREFERRED EMBODIMENTS

Hereinafter, respective preferred embodiments of the invention will be described in detail based on the drawings.

### First Embodiment

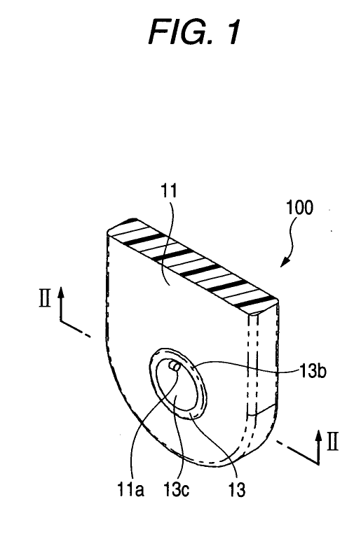

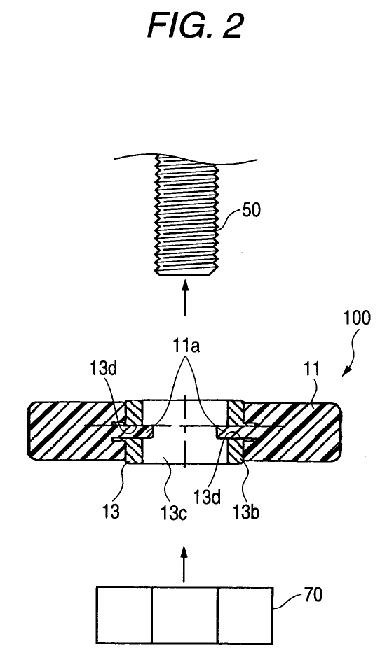

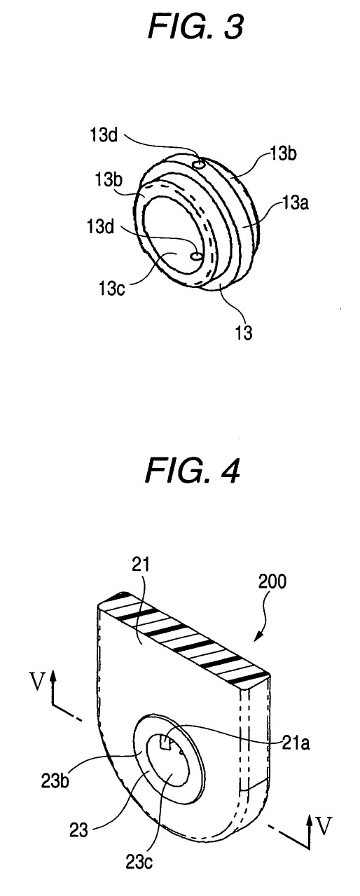

FIG. 1 is a perspective view of a fixing structure which is a first embodiment of the invention, FIG. 2 is a cross-sectional view of the fixing member taken along the line II-II in FIG. 1 as viewed in a direction indicated by arrows at ends of the line, and FIG. 3 is a perspective view of a collar in FIG. 1.

As shown in FIGS. 1 to 3, a fixing structure 100 is an attachment tab that is formed integrally on a fixed member (whose a main body is not shown) such as a junction block, a relay block, a protector, a bracket and the like. To be more specific, the fixing structure 100 includes a synthetic resin fixing part 11 that is formed on the fixed member (whose main body is not shown), a metallic collar 13 which is fixed to the fixing part 11 and which has a bolt insertion hole 13c, and two engaging protrusions 11a, 11a which are formed integrally with the fixing part 11 so as to protrude into the bolt insertion hole 13c of the collar 13. Then, a bolt thread 50 such as a bolt that is inserted into the bolt insertion hole 13c is engaged with the engaging protrusions 11a, 11a, whereupon the fixing part 11 (in other words, the fixed member (whose main body is not shown)) is provisionally fixed to the bolt thread 50. In this state, a nut 70 is fittingly screwed on a distal end portion of the bolt thread 50 which protrudes from the bolt insertion hole 13c.

The collar 13 is something like a hollow cylindrical member made of a metal in order to satisfy a mechanical strength that is required when the collar 13 is fastened by the bolt thread 50 and the nut 70 and has a large diameter portion 13a where the diameter is increased at an axially center thereof, small diameter portions 13b where the diameter is reduced on both sides of the large diameter portion 13a and a bolt insertion hole 13c which is a through hole that is defined by a circular edge portion of the collar 13 and which extends in an axial direction thereof. The collar 13 is such as to have two through holes 13d, 13d which penetrate from an outer peripheral surface thereof into the bolt insertion hole 13c and to be insert molded in the fixing part 11 of the fixed member (whose main body is not shown) such that the engaging protrusions 11a, 11a protrude into the bolt insertion hole 13c through the through holes 13d, 13d. The two through holes 13d, 13d are disposed so as to be spaced apart 180° from each other to thereby face each other.

Note that it is natural that the diameter of the bolt insertion hole 13c is made larger than the diameter of the bolt thread 50 such as a bolt planted on a vehicle body and that a distance between distal ends of the pair of engaging protrusions 11a, 11a is set to a dimension which is slightly smaller than the diameter of the bolt thread 50, whereby the bolt thread 50 is inserted into the bolt insertion hole 13c while deforming the engaging protrusions 11a, 11a. Then, the distal ends of the engaging protrusions 11a, 11a are brought into contact with a side surface of the bolt thread 50 to thereby be engaged with the bolt thread 50 by virtue of contact resistance generated then.

According to the fixing structure 100, since the fixed member (whose main body is not shown) falls from the bolt thread 50 in no case even in case the hands of an attachment worker are removed from the fixed member (whose main body portion is not shown) after the bolt thread 50 has been inserted into the bolt insertion hole 13c, fastening work using both the hands is enabled, and hence the fastening work can be performed with good efficiency. In addition, since the fixed member (whose main body is not shown) falls from the bolt thread 50 in no case, an erroneous assembly can be prevented. Additionally, since the collar 13 is insert molded in the fixing part of the fixed member (whose main body is not shown) such that the engaging protrusions 11a, 11a protrude into the bolt insertion hole 13c through the through holes 13d in the collar 13, the engaging protrusions 11a, 11a can be formed into the proper shape at the proper position with good efficiency and ease.

### Second Embodiment

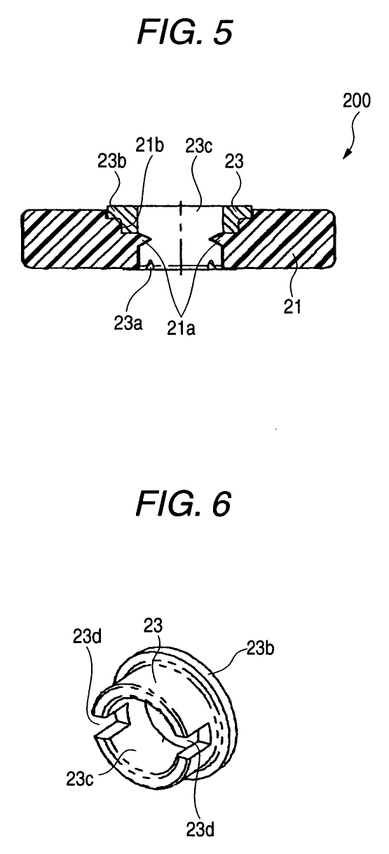

Next, a second embodiment will be described with reference to FIGS. 4 to 6. FIG. 4 is a perspective view of a fixing structure which is a second embodiment of the invention, FIG. 5 is a cross-sectional view of the fixing member taken along the line V-V in FIG. 4 as viewed in a direction indicated by arrows at ends of the line, and FIG. 6 is a perspective view of a collar shown in FIG. 4.

As shown in FIGS. 4 to 6, a fixing structure 200 is an attachment tab that is formed integrally on a fixed member (whose a main body is not shown) such as a junction block, a relay block, a protector, a bracket and the like. To be more specific, the fixing structure 200 includes a synthetic resin portion 21 to be fixed that is formed on the fixed member (whose main body is not shown), a metallic collar 23 which is fixed to the portion 21 to be fixed and which has a bolt insertion hole 23c, and two engaging protrusions 21a, 21a which are formed integrally with the portion 21 to be fixed so as to protrude into the bolt insertion hole 23c of the collar 23. Then, a bolt thread 50 (refer to FIG. 2) such as a bolt that is inserted into the bolt insertion hole 23c is engaged with the engaging protrusions 21a, 21a, whereupon the portion 21 to be fixed (in other words, the fixed member (whose main body is not shown)) is provisionally fixed to the bolt thread 50. In this state, a nut 70 is fittingly screwed on a distal end portion of the bolt thread 50 which protrudes from the bolt insertion hole 23c.

The collar 23 that fits in the portion 21 to be fixed is something like a hollow cylindrical member that is formed of a metal in order to satisfy a mechanical strength that is required when the collar 23 is fastened by the bolt thread 50 and the nut 70, and crimp portions 23 are formed at a peripheral end portion of the collar 23 which are crimp machined into the portion 21 to be fixed, whereas a flange portion 23b is formed on the other peripheral end portion thereof, the bolt insertion hole 23c being formed as a through hole that is defined by a circular edge portion and which extends in an axial direction of the collar 23.

The collar 23 has two slits 23d, 23d which penetrate from an outer peripheral surface thereof into the bolt insertion hole 23c and which is provided so as to extend axially from an axial end edge of the collar 23. The portion 21 to be fixed has a fitting hole 21b which fits on the outer peripheral surface of the collar 23. The engaging protrusions 21a, 21 are formed on an inner peripheral surface of the portion 21 to be fixed that defines the fitting hole 21b and protrude into the male inserting hole 23c while fitting in the slits 23d, 23d in the collar 23 when the collar 23 is fitted in the fitting hole 21b. The two slits 23d, 23d are disposed so as to be spaced apart 180° from each other so as to face each other.

Note that it is natural that the diameter of the bolt insertion hole 23c is made larger than the diameter of the bolt thread 50 such as a bolt planted on a vehicle body and that a distance between distal ends of the pair of engaging protrusions 21a, 21a is set to a dimension which is slightly smaller than the diameter of the bolt thread 50, whereby the bolt thread 50 is inserted into the bolt insertion hole 23c while deforming the engaging protrusions 21a, 21a. Then, the distal ends of the engaging protrusions 21a, 21a are brought into contact with a side surface of the bolt thread 50 to thereby be engaged with the bolt thread 50 by virtue of contact resistance generated then.

According to the fixing structure 200, since the fixed member (whose main body is not shown) falls from the bolt thread 50 in no case even in case the hands of the attachment worker are removed from the fixed member (whose main body portion is not shown) after the bolt thread 50 has been inserted into the bolt insertion hole 23c, fastening work using both the hands is enabled, and hence the fastening work can be performed with good efficiency. In addition, since the fixed member (whose main body is not shown) falls from the bolt thread 50 in no case, an erroneous assembly can be prevented. Additionally, the engaging protrusions 21a, 21a that are formed on the inner peripheral surface of the portion 21 to be fixed which defines the fitting hole 21b which fits on the outer peripheral surface of the collar 23 fit in the slits 23d, 23d in the collar 23 to thereby protrude into the bolt insertion hole 23c when the collar 23 is fitted in the fitting hole 21b. Because of this, the collar 23 and the fixed member (whose main body is not shown) can be prepared as separate components, whereby the collar 23 and the fixed member which are complex in shape can be prepared easily.

### Third Embodiment

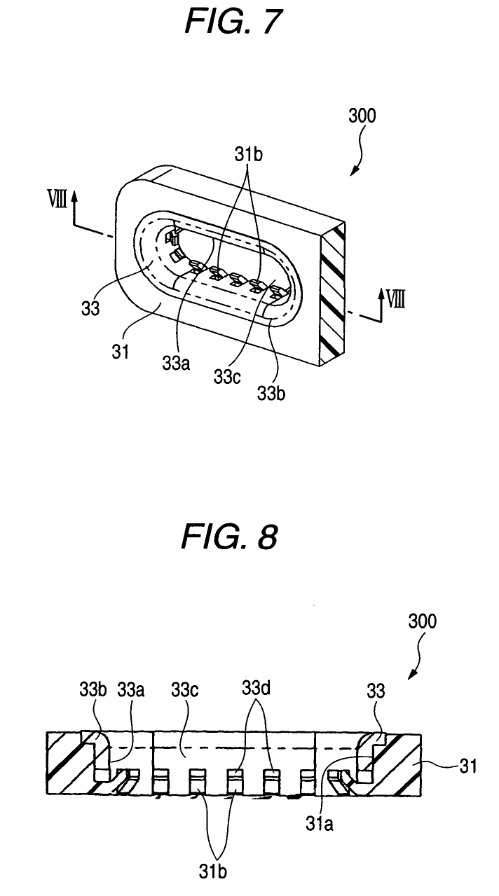

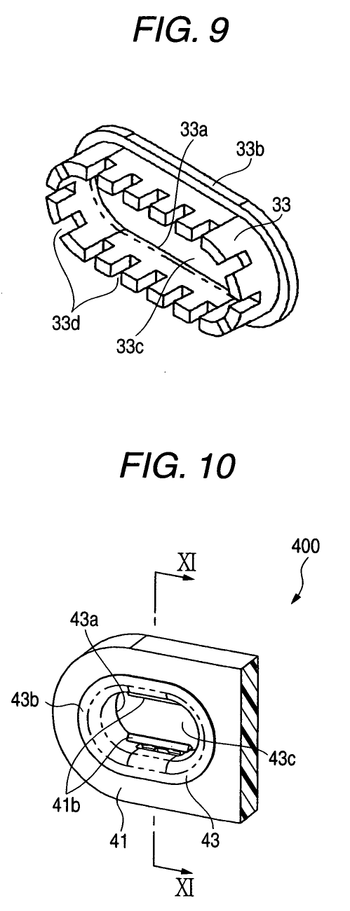

Next, a third embodiment will be described with reference to FIGS. 7 to 9. FIG. 7 is a perspective view of a fixing structure which is a third embodiment of the invention, FIG. 8 is a cross-sectional view of the fixing member taken along the line VIII-VIII in FIG. 8 as viewed in a direction indicated by arrows at ends of the line, and FIG. 9 is a perspective view of a collar shown in FIG. 7.

As shown in FIGS. 7 to 9, a fixing structure 300 is a fixing part 31 which is something like a rectangular plate-like convex portion and which is formed at part of a fixed member. A collar 33 fits in the fixing part 31, and a crimp portion (not shown) is formed at a peripheral end portion of the collar 33 that is crimp machined so that the collar 33 is fixed to the fixing part 31. In the metallic collar 33, a bolt insertion hole 33c that is defined in a flat circular shape by a flat circular edge portion 33a penetrates therethrough in an axial direction of the collar 33, and a flange portion 33b is formed at the other peripheral end portion of the collar 33. A plurality of slits 33d are disposed in a peripheral direction along the flat circular edge portion 33a at predetermined intervals so as to extend in the axial direction of the collar 33 from an opposite end edge to the flange portion 33b.

In the fixing part 31, which is part of the fixed member, an elongated hole (a fitting hole) 31a is formed which is defined by the flat circular edge portion and which fits on an outer peripheral surface of the collar 33, and a plurality of engaging protrusions 31b are formed to protrude so as to correspond to the plurality of slits 33d in the collar 33. The collar 33 is fitted in the fitting hole 31a while allowing the engaging protrusions 31b of the fixing part 31 to fit in the slits 33d, and a crimp portion (not shown) is formed by crimp machining an end of the collar 33, so that the collar 33 is fixed to the fixing part 31. As this occurs, the engaging protrusions 31b of the fixing part 31 slightly protrude into the inside of the bolt insertion hole 33c at distal ends thereof.

Note that the bolt insertion hole 33c that is formed into a flat circular shape is set such that the dimension of a shorter side thereof is set to be slightly larger than the diameter of a bolt thread 50 (refer to FIG. 2) such as a bolt planted on the vehicle body, whereas the dimension of a longer side is set to be far lager than the diameter of the bolt thread 50, for example, to a length that is on the order of three times as long as the diameter of the bolt thread 50. Consequently, the bolt thread 50 can be inserted at an arbitrary position in the male inserting hole 33c in the longitudinal direction thereof, so that the fixed member (the fixing part 31) can be fixed by absorbing any dimensional error occurring between the relevant constituent components. In addition, the bolt thread 50 so inserted is brought into contact with any of distal ends of the plurality of engaging protrusions 31b, whereby the fixing part 31 is provisionally fixed to the bolt thread 50 so inserted by virtue of contact resistance generated then.

According to the fixing structure 300, the bolt insertion hole 33c of the collar 33 is formed into the flat circular shape, and the plurality of slits 33d, which communicate between the bolt insertion hole 33c and the outer peripheral surface of the collar 33 and which are formed so as to extend axially from the one end edge of the collar 33, are disposed along the flat circular edge portion of the bolt insertion hole 33c. In addition, the flat circular fitting hole 31a, which fits on the outer peripheral surface of the collar 33, is provided in the fixed member (the fixing part 31), and the plurality of engaging protrusions 31b are formed so as to protrude into the inside of the fitting hole 31a. Then, the collar 33 is fitted in the fitting hole 31a, and the plurality of engaging protrusions 31b are made to fit in the corresponding slits 33d in the collar 33, respectively, so that the engaging protrusions 31b protrude into the inside of the bolt insertion hole 33c, whereby the bolt thread 50 inserted into the flat circular bolt insertion hole 33c is brought into contact with any of the plurality of engaging protrusions 31b to thereby provisionally fix thereto the fixing part 31. Namely, even in the event that the bolt thread 50 is inserted at any position within the flat circular bolt insertion hole 33c, the bolt thread 50 is brought into contact with any of the plurality of engaging protrusions 31b to thereby provisionally fix thereto the fixing part 31, whereby the fixed member (the fixing part) 31 can be fixed in an ensured fashion by absorbing any dimensional error occurring between the relevant constituent components by the flat circular bolt insertion hole 33c.

Since the function and advantage of the fixing structure 300 can easily be assumed from the description of the first and second embodiments, the description thereof will be omitted here.

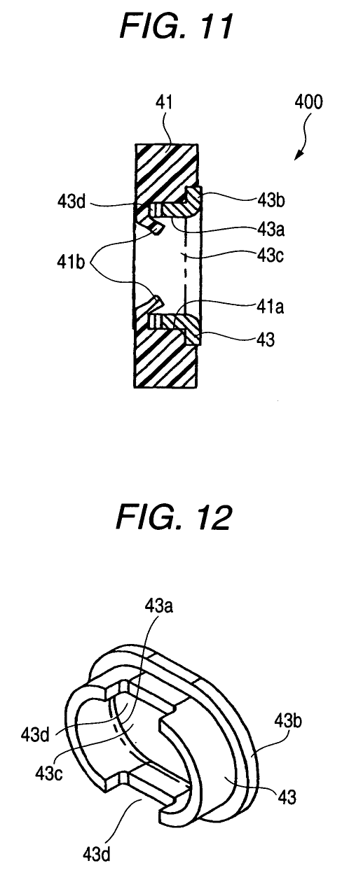

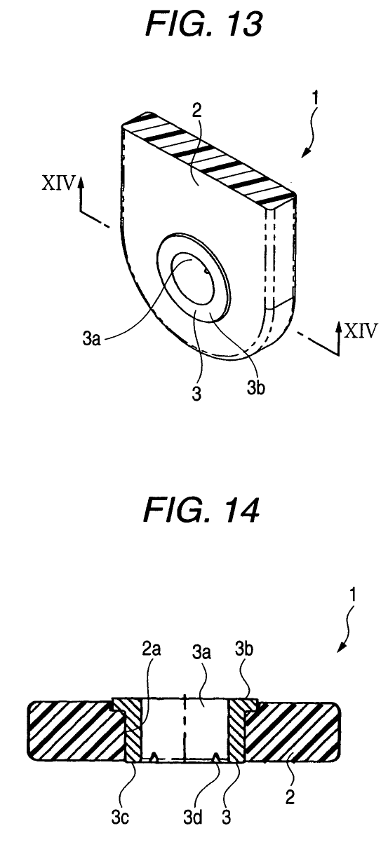

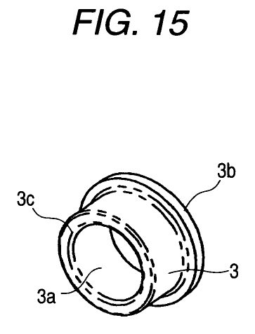

Next, a fourth embodiment will be described with reference to FIGS. 10 to 12. FIG. 10 is a perspective view of a fixing structure which is a fourth embodiment of the invention, FIG. 11 is a cross-sectional view of the fixing member taken along the line XI-XI in FIG. 10 as viewed in a direction indicated by arrows at ends of the line, and FIG. 12 is a perspective view of a collar shown in FIG. 10.

As shown in FIGS. 10 to 12, a fixing structure 400 a fixing part 41 which is something like a rectangular plate-like convex portion and which is formed at part of a fixed member. A collar 43 fits in the fixing part 41, and a crimp portion (not shown) is formed by crimp machining one end of the collar 43 so that the collar 43 is fixed to the fixing part 41. The metallic collar 43 is such that a bolt insertion hole 43c defined by a flat circular edge portion 43a penetrates therethrough in an axial direction of the collar 43 and a flange portion 43b is formed at a peripheral end portion. A pair of slits 43d which are formed into a U shape are provided in longer side portions which face the flat circular edge portion 43a so as to extend in the axial direction of the collar 43 from an opposite end edge to the flange portion 43b.

The fixing part 41, which is part of the fixed member, is such that an elongated hole (a fitting hole) 41a is formed that fits on an outer peripheral surface of the collar 43 and which is defined by the flat circular edge portion 43a and a pair of engaging protrusions 41b are formed inside the fitting hole 41a so as to protrude while corresponding to the pair of slits 43d in the collar 43. The collar 43 is made to fit in the fitting hole 41a while allowing the engaging protrusions 41b on the fixing part 41 to fit in the slits, respectively, and is fixed to the fixing part 41 by being crimp machined at the other peripheral end portion thereof so as to form a crimp portion. As this occurs, the engaging protrusions 41b of the fixing part 41 slightly protrude into the inside of the bolt insertion hole 43c at distal ends thereof.

Note that the bolt insertion hole 43c that is formed into a flat circular shape is set such that the dimension of a shorter side thereof is set to be slightly larger than the diameter of a bolt thread 50 (refer to FIG. 2) such as a bolt planted on the vehicle body, whereas the dimension of a longer side is set to be far lager than the diameter of the bolt thread 50. Consequently, the bolt thread 50 can be inserted at an arbitrary position in the male inserting hole 33c in the longitudinal direction thereof, whereby the fixed member (the fixing part 41) can be fixed by absorbing any dimensional error occurring between the relevant constituent components. In addition, the bolt thread 50 so inserted is brought into contact with any of distal ends of the plurality of engaging protrusions 41b, whereby the fixing part 41 is provisionally fixed to the bolt thread 50 so inserted by virtue of contact resistance generated then.

According to the fixing structure 400, the bolt insertion hole 43c of the collar 43 is formed into a flat circular shape, and the pair of slits 43d which penetrate from the bolt insertion hole 43c to the outer peripheral surface of the collar are formed in the facing longer side portion of the bolt insertion hole 43c so as to extend axially from the axial end edge of the collar 43. In addition, the flat circular fitting hole 41a, which fits on the outer peripheral surface of the collar 43, is formed in the fixed member (the fixing part) 41, and the pair of engaging protrusions 41b are formed on the facing longer side portions of the fitting hole 41a so as to protrude into the inside of the fitting hole 41a. Then, the collar 43 is made to fit in the fitting hole 41a, and the pair of engaging protrusions 41b are made to fit in the corresponding slits 43d of the collar 43, respectively, so that the pair of engaging protrusions 41b are allowed to protrude into the inside of the bolt insertion hole 43c. Namely, the distal ends of the pair of engaging protrusions 41b protrude into the inside of the bolt insertion hole 43c, whereby the bolt thread 50 inserted into the flat circular bolt insertion hole 43c is brought into contact with the pair of engaging protrusions 41b to thereby provisionally fix thereto the member 41 to be fixed. Namely, even in the event that the bolt thread 50 is inserted at any position in the flat circular bolt insertion hole 43c, the bolt thread 50 is brought into contact with the pair of engaging protrusions 41 in an ensured fashion, whereby the fixed member (the fixing part) 41 can be fixed in an ensured fashion by absorbing any dimensional error occurring between the relevant constituent components by the flat circular bolt insertion hole 43c.

Since the function and advantage of the fixing structure 300 can easily be assumed from the description of the first and second embodiments, the description thereof will be omitted here.

Note that the invention is not limited to the embodiments that have been described heretofore but may be altered and modified for improvement as appropriately. In addition, the materials, configurations, dimensions, numerical values, forms, numbers, disposition locations and the like that are described in the embodiments are not limited thereto but may be arbitrary, provided that they remain such as to attain the invention.

What is claimed is:

1. A fixing structure comprising:
a fixing part; and
a collar fixed in the fixing part and in which a bolt insertion hole is defined by an inner peripheral surface thereof;
wherein at least one engaging protrusion is protruded from the inner peripheral surface of the collar so as to be engageable with a bolt inserted in the bolt insertion hole such that the fixing part is provisionally fixed to the bolt.

2. A fixing structure according to claim 1, wherein the collar has a through hole which penetrates from an outer peripheral surface thereof into the bolt insertion hole, and the engaging protrusion protrudes from the inner peripheral surface to the bolt insertion hole through the through hole.

3. A fixing structure according to claim 1, wherein the collar is fixed in the fixing part by fitting the engaging protrusion to the through hole.

4. A fixing structure according to claim 1, wherein the fixing part is made of a synthetic resin and the collar is made of a metal, and
the engaging protrusion is integrally formed with the fixing part.

5. A fixing structure according to claim 4, wherein the collar is fixed in the fixing part by insert molding.

6. A fixing structure according to claim 1, wherein the collar has a slit which penetrates from an outer peripheral surface thereof into the bolt insertion hole, and the engaging protrusion protrudes from the inner peripheral surface to the bolt insertion hole through the slit.

7. A fixing structure according to claim 6, wherein the slit extends from an axial end of the collar,
the fixing part has a fitting hole that fits on the outer peripheral surface of the collar,
the engaging protrusion is fitted in the slit so as to protrude in the bolt insertion hole when the collar is fitted in the fitting hole.

8. A fixing structure according to claim 7, wherein a flange portion is formed in another axial end of the collar.

9. A fixing structure according to claim 1, wherein said at least one engaging protrusion is provided as a pair of the engaging protrusions which is opposite to each other on the inner peripheral surface.

10. A fixing structure according to claim 1, wherein the collar is substantially provided with a hollow cylindrical member formed of a metal.

11. A fixing structure according to claim, wherein the bolt insertion hole is defined in a flat circular shape in the collar, and plural pairs of the engaging protrusions are formed on the inner peripheral surface of the collar.
